(19) United States
(12) Patent Application Publication
(10) Pub. No.: US 2024/0292374 A1
(43) Pub. Date: Aug. 29, 2024

(54) FULL DUPLEX SIDELINK COMMUNICATION

(71) Applicant: QUALCOMM Incorporated, San Diego, CA (US)

(72) Inventors: Yan ZHOU, San Diego, CA (US); Hemant SAGGAR, San Diego, CA (US)

(21) Appl. No.: 18/173,586

(22) Filed: Feb. 23, 2023

(51) Int. Cl. H04W 72/02; H04L 5/00; H04L 5/14; H04W 72/1263

(52) U.S. Cl. CPC H04W 72/02; H04L 5/0048; H04L 5/14; H04W 72/1263; H04W 72/566

(57) ABSTRACT

Various aspects of the present disclosure generally relate to wireless communication. In some aspects, a user equipment (UE) may select sidelink resources for full duplex communication from among available sidelink resources. The UE may communicate in full duplex using the selected sidelink resources. Numerous other aspects are described.

### FIELD OF THE DISCLOSURE

Aspects of the present disclosure generally relate to wireless communication and to techniques and apparatuses for full duplex sidelink communication.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include selecting sidelink resources for full duplex communication from among available sidelink resources. The method may include communicating in full duplex using the selected sidelink resources.

Some aspects described herein relate to a UE for wireless communication. The UE may include a memory and one or more processors coupled to the memory. The one or more processors may be configured to select sidelink resources for full duplex communication from among available sidelink resources. The one or more processors may be configured to communicate in full duplex using the selected sidelink resources.

Some aspects described herein relate to a non-transitory computer-readable medium that stores a set of instructions for wireless communication by a UE. The set of instructions, when executed by one or more processors of the UE, may cause the UE to select sidelink resources for full duplex communication from among available sidelink resources. The set of instructions, when executed by one or more processors of the UE, may cause the UE to communicate in full duplex using the selected sidelink resources.

Some aspects described herein relate to an apparatus for wireless communication. The apparatus may include means for selecting sidelink resources for full duplex communication from among available sidelink resources. The apparatus may include means for communicating in full duplex using the selected sidelink resources.

Aspects generally include a method, apparatus, system, computer program product, non-transitory computer-readable medium, UE, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of selecting sidelink resources, in accordance with the present disclosure.

FIG. 6 is a diagram illustrating an example of full duplex sidelink communication, in accordance with the present disclosure.

FIG. 7 is a diagram illustrating an example associated with full duplex sidelink communication, in accordance with the present disclosure.

FIG. 8 is a diagram illustrating an example associated with full duplex sidelink communication, in accordance with the present disclosure.

FIG. 9 is a diagram illustrating an example of channel prioritization for half-duplex, in accordance with the present disclosure.

FIG. 10 is a diagram illustrating an example of channel prioritization for full duplex, in accordance with the present disclosure.

FIG. 11 is a diagram illustrating an example process performed, for example, by a UE, in accordance with the present disclosure.

FIG. 12 is a diagram of an example apparatus for wireless communication, in accordance with the present disclosure.

### DETAILED DESCRIPTION

A user equipment (UE) may operate using half-duplex for sidelink communication, where the sidelink UE does not transmit and receive at the same time as in full duplex communication. Therefore, if a sidelink resource (e.g., frequency in a time slot) is reserved by a UE for its own transmission in half-duplex communication, the sidelink resource is excluded from consideration for reception by the UE.

In some scenarios, such as with vehicle-to-everything (V2X), a vehicle or roadside unit (RSU) may be an example of a sidelink UE that is capable of sidelink communications. The vehicle or RSU may have multiple panels or arrays of antennas that can be used for sidelink communication. The amount of space between a transmit antenna array and a receive antenna array may be large enough to ensure sufficient spatial isolation and minimize self-interference between the transmit array and the receive array. According to various aspects described herein, a UE may be able to operate using full duplex for sidelink communication if it can ensure low self-interference (SI) between its transmit and receive antenna arrays. The UE may select sidelink resources for full duplex communication from among available sidelink resources. The UE may communicate in full duplex using the selected sidelink resources. As a result of using full duplex, throughput increases or latency decreases.

In some aspects, such as for sidelink mode 2, the UE, which is capable of full-duplex communication, may sense for available sidelink resources from among candidate sidelink resources that include scheduled sidelink resources already scheduled for transmission or reception by the UE. In some aspects, such as for sidelink mode 1, the UE may receive an indication of available sidelink resources from a network entity. The UE may select sidelink resources for full duplex communication from among the available sidelink resources and from among scheduled sidelink resources that are already scheduled for transmission or reception by the UE.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

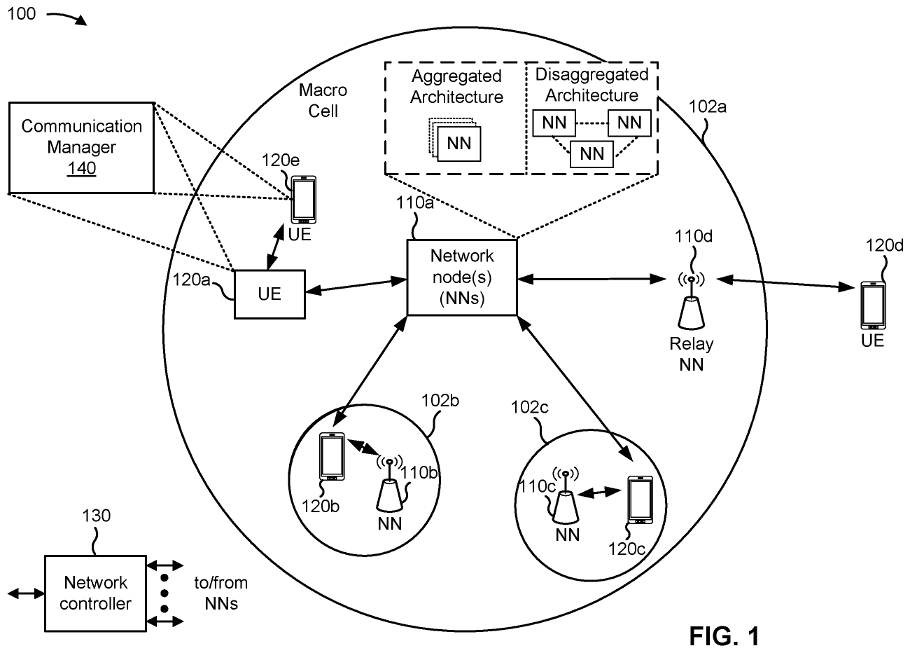

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a V2X protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR2-2, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, a UE (e.g., a UE 120) may include a communication manager 140. As described in more detail elsewhere herein, the communication manager 140 may select sidelink resources for full duplex communication from among available sidelink resources. The communication manager 140 may communicate in full duplex using the selected sidelink resources. Additionally, or alternatively, the communication manager 140 may perform one or more other operations described herein.

As indicated above, FIG. 1 is provided as an example. Other examples may differ from what is described with regard to FIG. 1.

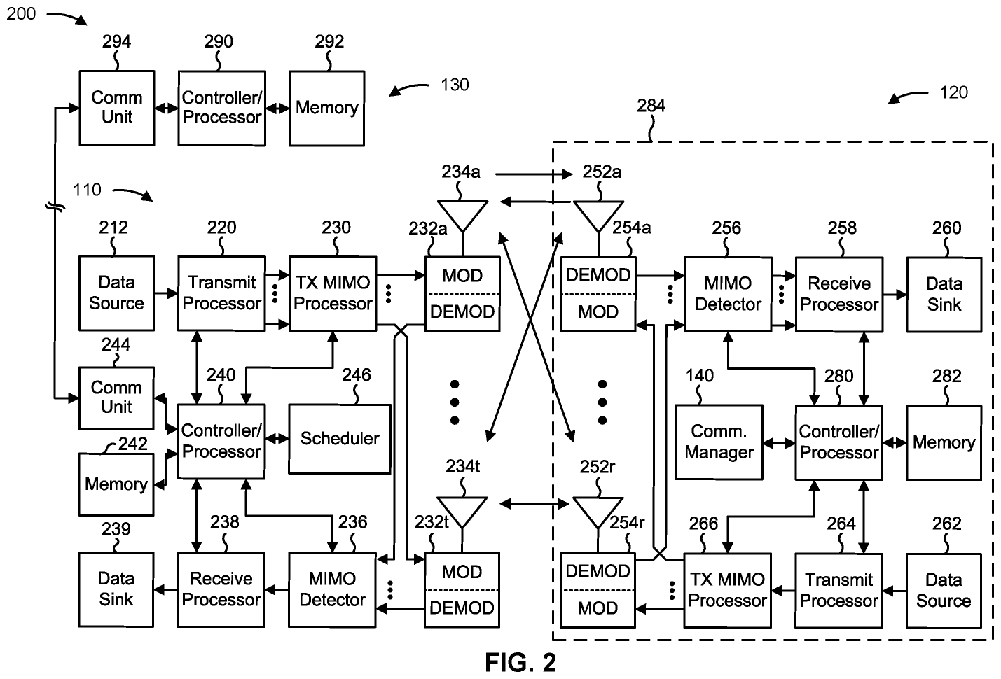

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

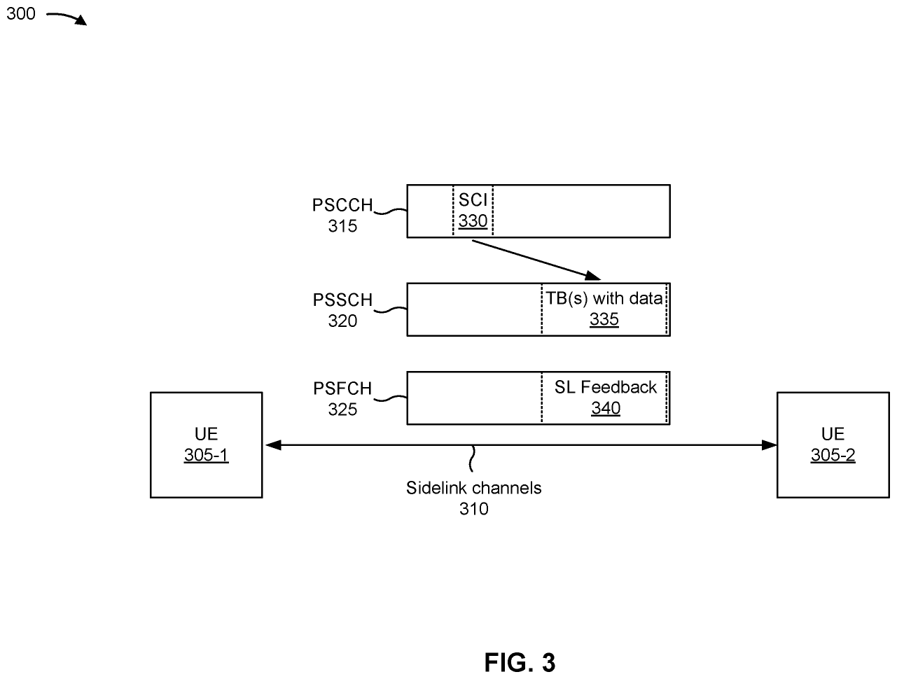

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 3-11).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 3-11).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

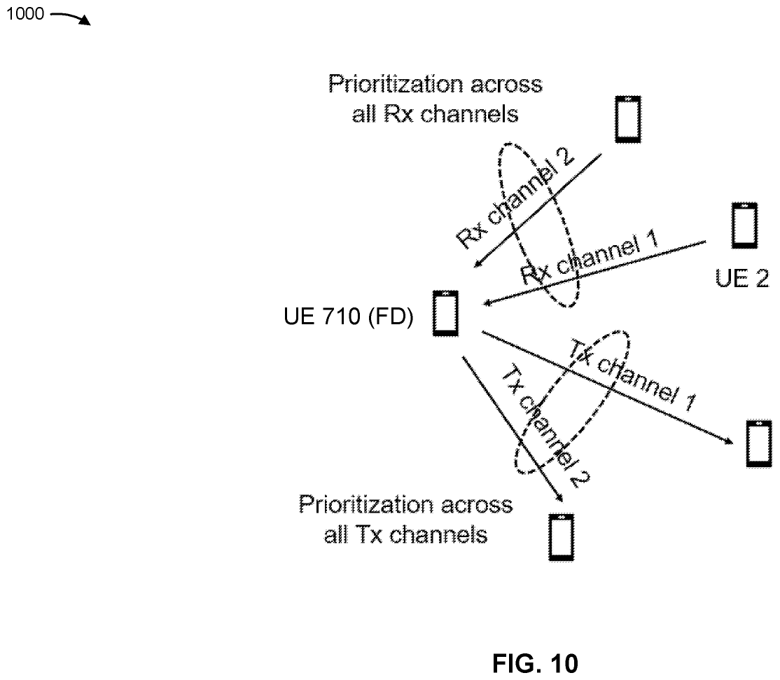

The controller/processor 240 of the network node 110, the controller/processor 280 of the UE 120, or any other component(s) of FIG. 2 may perform one or more techniques associated with full duplex sidelink communication, as described in more detail elsewhere herein. For example, the controller/processor 240 of the network node 110, the controller/processor 280 of the UE 120, or any other component(s) (or combinations of components) of FIG. 2 may perform or direct operations of, for example, process 1000 of FIG. 10, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1000 of FIG. 10, and/or other processes as described herein. In some examples, executing instructions may include running the instructions, converting the instructions, compiling the instructions, and/or interpreting the instructions, among other examples.

In some aspects, a UE (e.g., a UE 120) includes means for selecting sidelink resources for full duplex communication from among available sidelink resources; and/or means for communicating in full duplex using the selected sidelink resources. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a network node 110 via an access link or an access channel. The PSSCH 320 may be used to communicate data, similar to a physical downlink shared channel (PDSCH) and/or a physical uplink shared channel (PUSCH) used for cellular communications with a network node 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH DMRS pattern, an SCI format for the SCI-2, a beta offset for the SCI-2, a quantity of PSSCH DMRS ports, and/or an MCS. The SCI-2 may include information associated with data transmissions on the PSSCH 320, such as a HARQ process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., mode 1) where resource selection and/or scheduling is performed by a network node 110. For example, the UE 305 may receive a grant (e.g., in downlink control information (DCI) or in a radio resource control (RRC) message, such as for configured grants) from the network node 110 for sidelink channel access and/or scheduling. In some aspects, a UE 305 may operate using a transmission mode (e.g., mode 2) where resource selection and/or scheduling is performed by the UE 305 (e.g., rather than a network node 110). In some aspects, the UE 305 may perform resource selection and/or scheduling by sensing channel availability for transmissions. For example, the UE 305 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or an MCS to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

A medium access control (MAC) protocol data unit (PDU) sub-header may include a source ID (e.g., 16 bit SRC) and a destination ID (e.g., 9 bit DST). SCI may include a 16 bit destination ID and an 8 bit source ID. If a TB is associated with unicast, the DST field of the decoded MAC PDU sub-header is equal to the 8 most significant bits (MSB) of any of the source Layer-2 ID(s) of the UE for which the 16 least significant bits (LSB) are equal to the destination ID in the corresponding SCI, and the SRC field of the decoded MAC PDU sub-header is equal to the 16 MSB of any of the destination Layer-2 ID(s) of the UE for which the 8 LSB are equal to the source ID in the corresponding SCI. For unicast, a receiver UE is expected to check both the source ID and the destination ID. If the TB is associated with groupcast or broadcast and the DST field of the decoded MAC PDU sub-header is equal to the 8 MSB of any of the destination Layer-2 ID(s) of the UE for which the 16 LSB are equal to the destination ID in the corresponding SCI, the receiver UE is expected to only check the destination ID.

As indicated above, FIG. 3 is provided as an example. Other examples may differ from what is described with respect to FIG. 3.

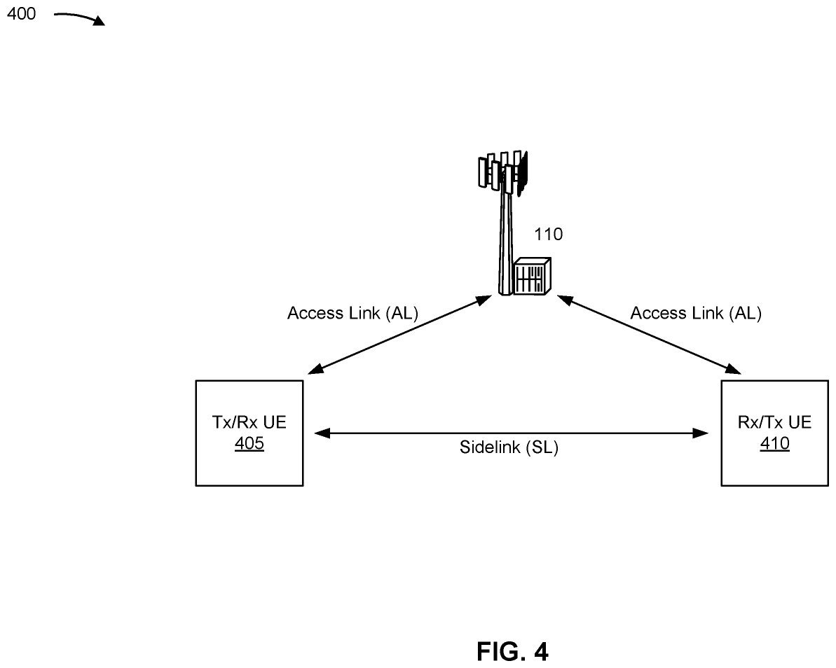

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a network node 110 may communicate with the Tx/Rx UE 405 via a first access link. Additionally, or alternatively, in some sidelink modes, the network node 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a network node 110 and a UE 120 (e.g., via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

As indicated above, FIG. 4 is provided as an example. Other examples may differ from what is described with respect to FIG. 4.

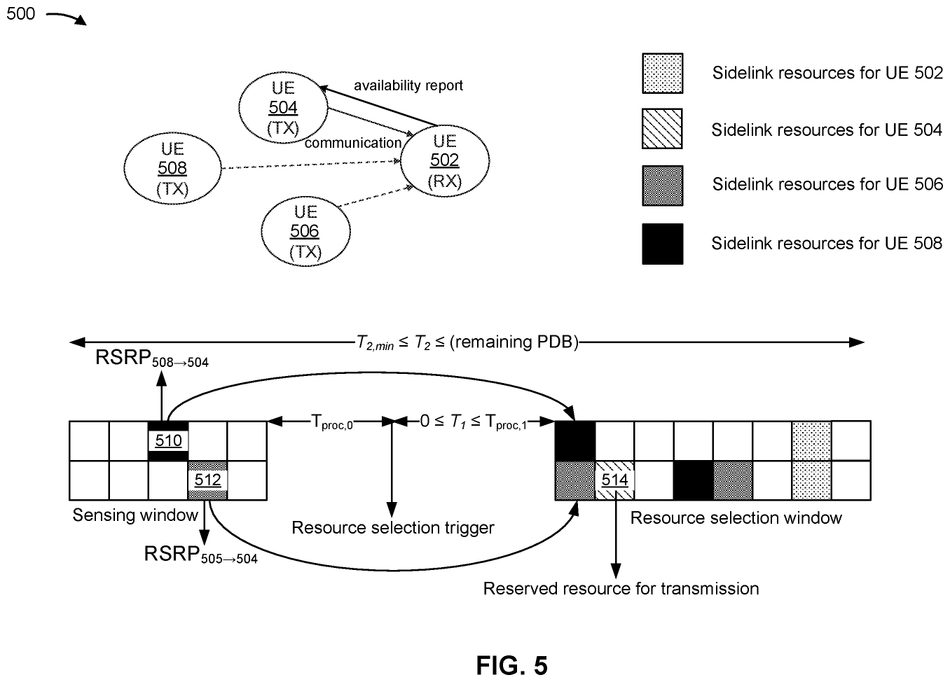

FIG. 5 is a diagram illustrating an example 500 of selecting sidelink resources, in accordance with the present disclosure. Example 500 shows a UE 502 (e.g., a UE 120) that may receive communications on a sidelink channel from other UEs, such as UE 504, UE 506, and/or UE 508.

As described in connection with FIG. 5, UE 504 is a transmitting UE that is transmitting communications to UE 502, which is a receiving UE. UE 504 may use a report from UE 502, which may act as a reporting UE that reports available sidelink resources, preferred sidelink resources, non-preferred sidelink resources, or sidelink resource conflicts. Example 500 shows an availability report from UE 502 to UE 504 and a communication from UE 504 to UE 502.

If UE 504 is to transmit a communication to UE 502, UE 504 may sense the sidelink channel in a sensing window to determine which sidelink resources (e.g., subcarriers, subchannels) are available. UE 504 may use a listen-before-talk (LBT) procedure to sense the channel. The LBT procedure maybe a type 1 LBT procedure, where UE 504 listens for multiple slots (e.g., 9 milliseconds (ms)) and uses a counter. A sidelink resource may be considered available if the sidelink resource was clear or had a signal energy (e.g., RSRP) that satisfied an availability threshold (e.g., measured interference or energy on the channel is lower than a maximum decibel-milliwatts (dBm) or dB, RSRP threshold). The availability threshold may be configured or preconfigured per transmission priority and receive priority pair. UE 504 may measure DMRSs on a PSCCH or a PSSCH, according to a configuration.

For example, UE 504 may prepare to transmit a communication to UE 502. UE 504 may have already sensed previous sidelink resources and successfully decoded SCI from UE 506 and UE 508. UE 504 may try to reserve sidelink resources, and thus may check the availability of the future sidelink resources reserved by UE 506 and UE 508 by sensing the sidelink channel in the sensing window. UE 504 may measure an RSRP of a signal from UE 508 in sidelink resource 510, and an RSRP of a signal from UE 506 in sidelink resource 512. If an observed RSRP (RSRP projection) satisfies the RSRP threshold (e.g., is lower than a maximum RSRP), the corresponding sidelink resource may be available for reservations by UE 504. UE 504 may reserve the sidelink resource (which may be a random selection from available resources). For example, UE 504 may select and reserve sidelink resource 514 for transmission. This may be in a time slot after which UE 506 and UE 508 had used sidelink resources, and UE 504 may have sensed these sidelink resources earlier. UE 504 may select and reserve sidelink resources only upon reaching at least a threshold level of available sidelink resources (e.g., 20%, 30%, or 50% availability). UE 504 may increase or decrease the RSRP threshold as necessary to arrive at the threshold level. UE 504 may select and reserve sidelink resources in the current slot and up to two (or more) future slots. Reservations may be aperiodic or periodic (e.g., SCI signals period between 0 ms and 1000 ms). Periodic resource reservation may be disabled.

There may be a resource selection trigger to trigger selection of sidelink resources after a processing time T_{proc,0}, and before another processing time T_{proc,1} before a resource selection window from which sidelink resources are available. The resource selection window may be a time window from which sidelink resources may be selected, and the resource selection window may extend for a remaining packet delay budget (PDB).

As indicated above, FIG. 5 is provided as an example. Other examples may differ from what is described with regard to FIG. 5.

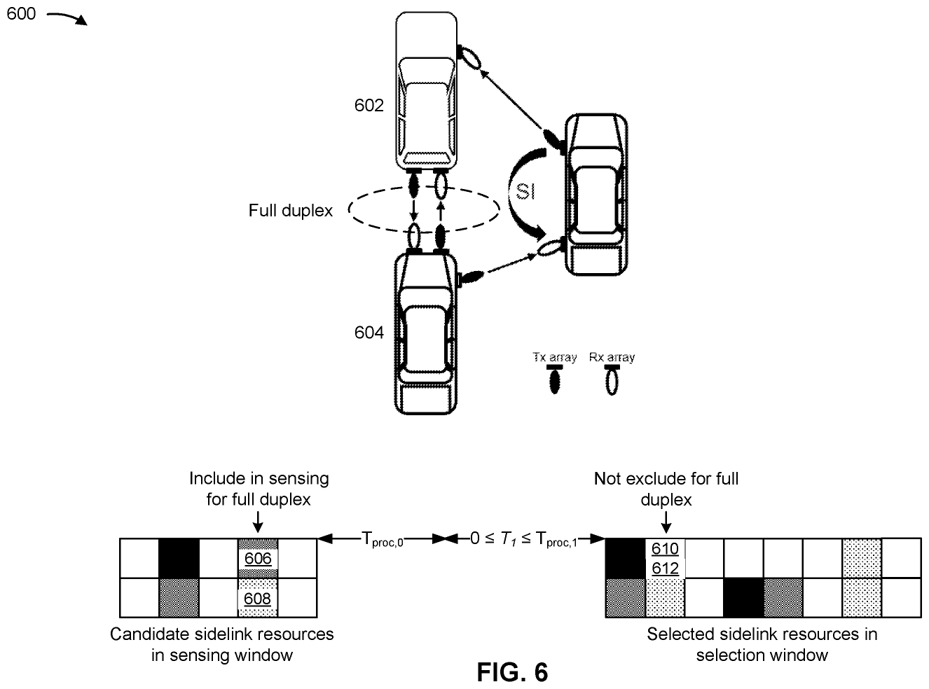

FIG. 6 is a diagram illustrating an example 600 of full duplex sidelink communication, in accordance with the present disclosure.

UEs typically operate using half-duplex for sidelink communication, where a UE does not transmit and receive at the same time as in full duplex communication. Therefore, if a sidelink resource (e.g., frequency in a time slot) is reserved by a UE for its own transmission in half-duplex communication, the sidelink resource (or the whole time slot) is excluded from consideration for reception by the UE. The sidelink resources may be periodic resources.

In some scenarios, such as V2X, a vehicle or an RSU may have multiple panels or arrays of antennas that can be used for sidelink communication. Example 600 shows vehicles with one or more transmit (Tx) arrays for transmission and one or more receive (Rx) arrays for reception. The amount of space between the transmit array and the receive array may be large enough to ensure sufficient spatial isolation between the transmit array and the receive array and minimizing the self-interference. SI for the antenna arrays can be further reduced due to a larger beamforming gain with more antenna elements per panel/array in cases of FR2 and FRx. According to various aspects described herein, a UE, such as the vehicle in example 600, may be able to operate using full duplex for sidelink communication. The UE may select sidelink resources for full duplex communication from among available sidelink resources. The UE may communicate in full duplex using the selected sidelink resources. As a result of using full duplex, throughput increases. Transmission or reception may occur in an earlier time slot, which also reduces latency.

In some aspects, such as for sidelink mode 2, the UE, which is capable of full-duplex communication, may sense for available sidelink resources from among candidate sidelink resources that include scheduled sidelink resources already scheduled for transmission or reception by the UE. Example 600 shows that a UE 602 of a first vehicle may communicate with a UE 604 of a second vehicle using full duplex communication. UE 602 may have reserved sidelink resource 606 and sidelink resource 608 for transmission (reception by UE 604), and there are no other resources available in the time slot for reception from UE 604. Because UE 602 and UE 604 are configured for full duplex sidelink communication, UE 602 may sense for available resources from among candidate sidelink resources (in the sensing window), including in the time slot for sidelink resource 606 and sidelink resource 608. UE 602 may provide UE 604 with reservation information (e.g., in an inter-UE coordination (IUC) message or through a reservation announcement in SCI-1) that indicates that sidelink resource 606 and sidelink resource 608 can be used for transmission by UE 604.

Full duplex communication makes it possible for UE 602 to select, for full duplex communication, sidelink resource 606 and/or sidelink resource 608 for reception at the same time as a scheduled transmission in these sidelink resources. For example, in the selection window, there may be a reception direction 610 and a transmission direction 612 in a same sidelink resource (e.g., sidelink resource 608). This is not possible with sensing for half-duplex communication. Full duplex communication may provide for transmission in an earlier time slot than half-duplex communication. The positive impact may be even greater if the reception would otherwise have to wait until a next sensing window and a next selection window due to a busy sidelink channel (e.g., multiple communicating vehicles surrounding the vehicle for UE 602).

While example 600 is described as sensing for reception by UE 602, these aspects may also apply to transmission by UE 602. UE 602 may have reservation information from UE 604 that indicates that UE 604 is using sidelink resource 606 and sidelink resource 608 for transmission, and there are no other resources available in the time slot. Because UE 602 and UE 604 are configured for full duplex communication, UE 602 may sense for available resources from among candidate sidelink resources (in the selection window), including sidelink resource 606 and sidelink resource 608.

In some aspects, such as for sidelink mode 1, UE 602 may receive an indication of available sidelink resources from a network entity. UE 602 may select sidelink resources for full duplex communication from among the available sidelink resources and from among scheduled sidelink resources that are already scheduled for transmission or reception by UE 604. For example, the network entity may have indicated that sidelink resource 606 and sidelink resource 608 are already scheduled for transmission by UE 604. UE 602 may select a sidelink direction for a sidelink resource that is available if full duplex communication is to be used. The sidelink direction may include transmission by UE 602 in sidelink resource 606 or sidelink resource 608.

As indicated above, FIG. 6 is provided as an example. Other examples may differ from what is described with regard to FIG. 6.

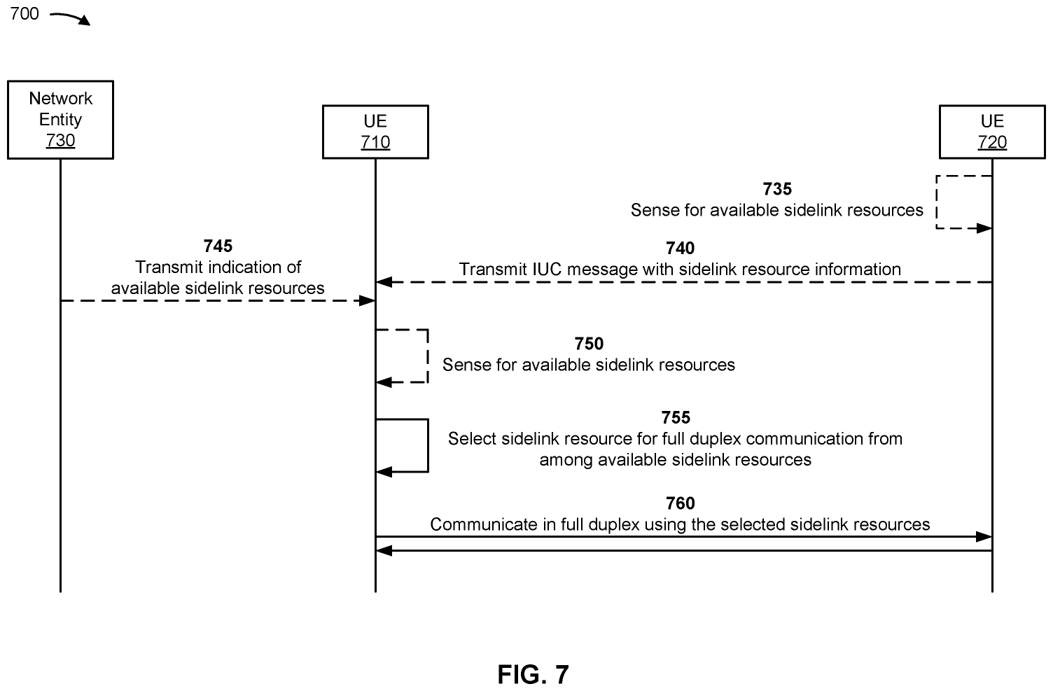

FIG. 7 is a diagram illustrating an example 700 associated with full duplex sidelink communication, in accordance with the present disclosure. As shown in FIG. 7, a first UE 710 (e.g., a UE 120) and a second UE 720 (e.g., a UE 120) may communicate with one another via a sidelink. UE 710 may determine its own full duplex resources.

UE 710 and UE 720 may each be configured for full duplex communication. UE 710 and/or UE 720 may have received an indication to activate or enable full duplex communication, or UE 710 and/or UE 720 may have autonomously determined to enter full duplex mode based at least in part on traffic conditions, channel conditions, and/or a UE capability (e.g., hardware capability, software capability) for full duplex communication. UE 710 may have received a configuration for full duplex communication that indicates whether full duplex communication is to be performed in slots of the selected sidelink resources or in a whole sensing window. UE 710 may disable a half-duplex check condition based at least in part on a higher layer parameter.

In some aspects, whether UE 710 can perform full duplex at least in those slots is determined by UE 710. In some aspects, a network entity, another UE, or another third-party node may indicate to UE 710 whether UE 710 is to perform full duplex communication in at least in the scheduled slots. For example, UE 710 may report its full duplex capability, and the network entity or third-party node may indicate (e.g., via RRC, message, a MAC control element (MAC CE), or DCI) whether full duplex is to be performed at least in the scheduled slots or in a larger window. In some aspects, the larger window may be the whole sensing window (e.g., in sidelink mode 2). In some aspects, the larger window may be an allocated resource window (e.g., in sidelink mode 1).

As shown by reference number 735, UE 720 may sense for available sidelink resources. As shown by reference number 740, UE 720 may transmit an IUC message with sidelink resource information that is based at least in part on the sensing. This may be applicable to sidelink mode 2, and the sidelink resource information may indicate sidelink resources reserved by UE 720.

For sidelink mode 1, a network entity 730 may transmit an indication of available sidelink resources, as shown by reference number 745. UE 720 may skip the sensing and the transmission of an IUC message. In some aspects, UE 710 may down-select resources based at least in part on a priority.

As shown by reference number 750, UE 710 may, optionally, sense for available sidelink resources. UE 710 may sense for available sidelink resources from among candidate sidelink resources. The candidate sidelink resources may include sidelink resources that may be reserved for one direction but allow for transmission in the other direction when using full duplex communication. That is, in the sensing window, UE 710 may not skip monitored slots in which its own transmission is scheduled, if UE 710 can perform full duplex at least in the scheduled slots. Corresponding periodic resources may be excluded from available resources in the resource selection window only if there is actually such a periodic resource reservation sensed during the sensing window.

As shown by reference number 755, UE 710 may select sidelink resources for full duplex communication from among the available sidelink resources. As shown by reference number 760, UE 710 and UE 720 may communicate in full duplex using the selected sidelink resources. This may include UE 710 providing sidelink reservation information to UE 720.

Note that the order of the sensing at UE 710 or UE 720 and the transmission or reception of IUC messages may vary in order, as long as such steps contribute to the selection of full duplex resources for a future full duplex communication session. For example, the sensing at UE 710 may occur before UE 710 receives any IUC messages.

As indicated above, FIG. 7 is provided as an example. Other examples may differ from what is described with regard to FIG. 7.

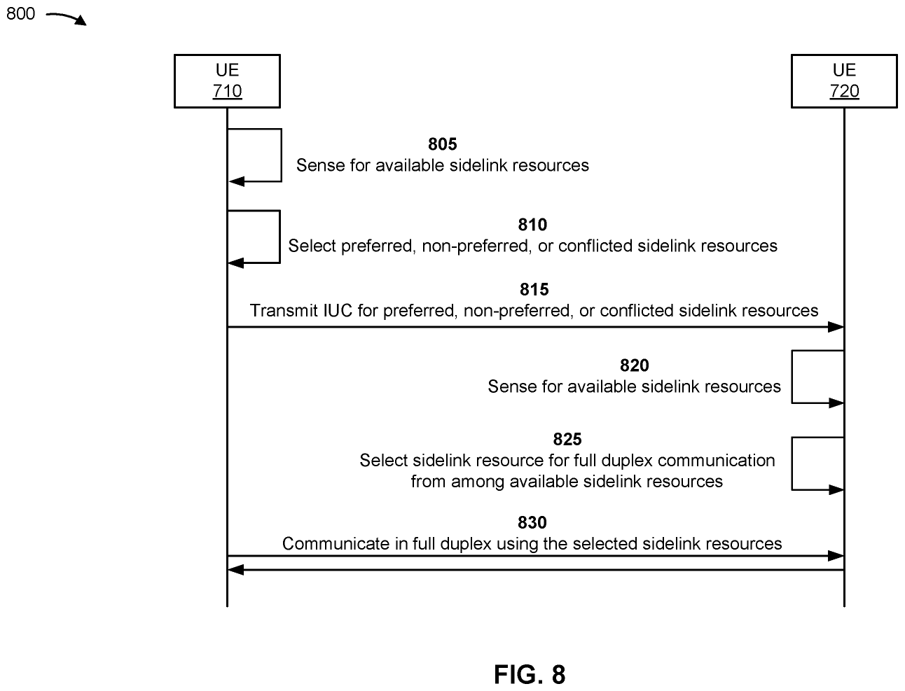

FIG. 8 is a diagram illustrating an example 800 associated with full duplex sidelink communication, in accordance with the present disclosure.

Current techniques for preferred resource or non-preferred resource determination for IUC exclude sidelink resources scheduled for transmission by a UE from preferred resources for reception and include such sidelink resources into non-preferred resources for reception, by assuming the UE can only perform half-duplex. However, such sidelink resources can be used for reception while the UE is transmitting if the UE can perform full duplex.

As shown by reference number 805, UE 710 may sense for available sidelink resources from among candidate sidelink resources. In some aspects, the candidate sidelink resources may include sidelink resources that may be reserved for one direction but allow for transmission in the other direction when using full duplex communication. That is, in the sensing window, UE 710 may not skip monitored slots in which its own transmission is scheduled, if UE 710 can perform full duplex at least in the scheduled slots.

As shown by reference number 810, UE 710 may select preferred, non-preferred, or conflicted sidelink resources. UE 710 may select preferred resources from among available resources that could include sidelink resources already scheduled for transmission or reception. For example, when determining a preferred sidelink resource, at least for an intended reception, UE 710 may not exclude time resources/slots in which its own transmission will occur, if UE 710 can perform full duplex at least in those time resources/slots. When determining non-preferred sidelink resources at least for intended reception, UE 710 may not include scheduled time resources/slots in which its own transmission will occur if UE 720 can perform full duplex at least in those scheduled time resources/slots. In some aspects, UE 710 may determine whether UE 710 can perform full duplex at least in the scheduled time resources/slot. In some aspects, the network or a third-party node may make the determination and indicate the determination to UE 710.

Existing techniques for conflicted sidelink resource determination for IUC include resources where a UE will transmit, into a conflicted sidelink resource for scheduled reception, by assuming the UE can only perform half-duplex. However, the conflicted sidelink resource can still be used for reception while the UE is transmitting if the UE can perform full duplex communication. In some aspects, UE 710 may select conflicted sidelink resources that conflict with other sidelink resources and that are not among time resources for which transmission is available with full duplex communication. For example, when determining conflicted resources at least for intended reception, UE 710 may not include time resources/slots in which its own transmission will occur if UE 710 can perform full duplex communication in at least in those time resources/slots. As shown by reference number 815, UE 710 may transmit an indication of the preferred, non-preferred, or conflicted sidelink resources in an IUC message.

As shown by reference number 820, UE 720 may also sense for available sidelink resources. UE 720 may sense for available sidelink resources from among candidate sidelink resources. The candidate sidelink resources may include sidelink resources that may be reserved for one direction but allow for transmission in the other direction when using full duplex communication. That is, in the sensing window, UE 720 may not skip monitored slots in which its own transmission is scheduled, if UE 720 can perform full duplex at least in the scheduled slots. Corresponding periodic resources may be excluded from available resources in the resource selection window only if there is actually such a periodic resource reservation sensed during the sensing window.

As shown by reference number 825, UE 720 may select sidelink resources for full duplex communication from among the available sidelink resources. As shown by reference number 830, UE 710 and UE 720 may communicate in full duplex using the selected sidelink resources. This may include UE 720 providing sidelink reservation information to UE 710.

Note that the order of the sensing at UE 710 or UE 720, the transmission or reception of IUC messages, and the selection of preferred, non-preferred, or conflicted resources may vary in order, as long as such steps contribute to the selection of full duplex resources for a future full duplex communication session. For example, the sensing at UE 720 may occur before UE 720 receives any IUC messages.

As indicated above, FIG. 8 is provided as an example. Other examples may differ from what is described with regard to FIG. 8.

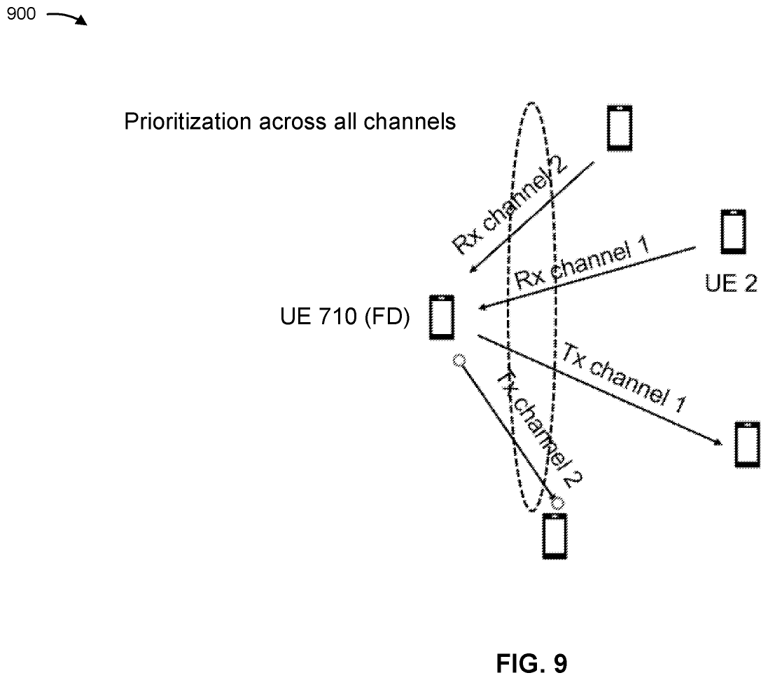

FIG. 9 is a diagram illustrating an example 900 of channel prioritization for half-duplex, in accordance with the present disclosure.

Channel prioritization may occur in half-duplex when at least one transmit channel and at least one receive channel overlap in time at the sidelink UE. However, there are limitations due to half-duplex communication, which result in only transmission or reception of a channel or reference signal (RS). Example 900 shows Rx channel 1, Rx channel 2, Tx channel 1, and Tx channel 2 for UE 1. Example 900 also shows prioritization across all of the channels. The UE (e.g., UE 1) may prioritize one channel across all overlapping transmit and receive channels, but only one transmit or receive channel will be finally prioritized due to the half-duplex UE assumption. Also, channel prioritization may occur if at least one LTE channel/RS overlaps with at least one NR sidelink channel/RS at the sidelink UE with reverse transmit/receive directions. The RAT's channel(s)/RS(s) with the highest priority among all overlapped channels/RSs is prioritized for transmission or reception, assuming that the UE performs half-duplex only. If at least one PSFCH overlaps with at least one PSFCH at the sidelink UE with reverse transmit/receive directions, the PSFCH(s) with the highest priority among all overlapped PSFCHs is prioritized for transmission or reception, assuming half-duplex communication. If at least one sidelink channel/RS overlaps with at least one uplink channel/RS at the sidelink UE with reverse transmit/receive directions, the sidelink or uplink channel(s)/RS(s) with the highest priority among all overlapped channels/RSs is prioritized for transmission or reception, assuming half-duplex communication.

As indicated above, FIG. 9 is provided as an example. Other examples may differ from what is described with regard to FIG. 9.

FIG. 10 is a diagram illustrating an example 1000 of channel prioritization for full duplex, in accordance with the present disclosure.

In some aspects, UE 710 may perform prioritization across all receive channels and separately perform prioritization across all transmit channels. Example 1000 shows Rx channel 1, Rx channel 2, Tx channel 1, and Tx channel 2 for UE 1. Example 1000 also shows prioritization across all Rx channels and prioritization across all Tx channels.

UE 710 may select, based at least in part on a transmission priority, a set of transmit channels or RSs from among overlapping-in-time transmit channels or RSs to other UEs. UE 710 may select a highest priority channel or RS for transmission. UE 710 may select, based at least in part on a reception priority, a set of receive channels or RSs from among overlapping-in-time receive channels or RSs from other UEs. UE 710 may select a highest priority channel or RS for reception. UE 710 may then transmit one or more first communications (e.g., sidelink, uplink) on the selected set of transmit channels or RSs and receive one or more second communications (e.g., sidelink, downlink) on the selected set of receive channels or RSs in a same time resource. This may result in both transmission and reception with prioritized channels, which improves throughput.

In some aspects, the set of transmit channels or RSs and the set of reception channels or RSs may have the following combinations. The transmission set and the reception set may belong to different RATs (e.g., LTE versus NR). The transmission set and the reception set may belong to the same type of channel/RS but with different directions (e.g., PSFCH for transmission versus PSFCH for reception). The transmission set and the reception set may belong to different link types (e.g., uplink versus sidelink).

In some aspects, UE 710 may determine the priority per transmit/receive channel or RS via an existing rule or a new extended rule. In some aspects, UE 710 may determine the priority by the SCI/DCI/MAC CE scheduling or activating the transmit channel/RS or the receive channel/RS. For example, the priority may be provided by RRC or by a fixed rule specified in stored configuration information at least for periodic channels/RSs. For example, the rule may specify the priority between a synchronization signal block (SSB) in Uu and sidelink, the priority between a PSFCH and a PUCCH communication not carrying HARQ feedback (e.g., only carrying CSI information). The priority may be the same as the associated transmit channel/RS or receive channel/RS. For example, a PSFCH or PUCCH communication carrying HARQ feedback may have the same priority as a corresponding PSSCH or PDSCH communication carrying the traffic.

As indicated above, FIG. 10 is provided as an example. Other examples may differ from what is described with regard to FIG. 10.

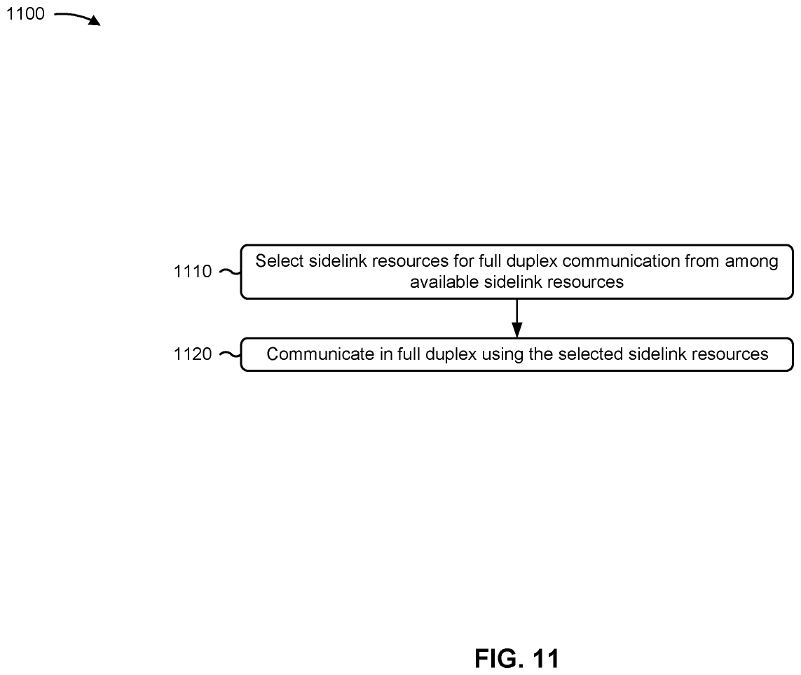

FIG. 11 is a diagram illustrating an example process 1100 performed, for example, by a UE, in accordance with the present disclosure. Example process 1100 is an example where the UE (e.g., UE 120) performs operations associated with full duplex sidelink communication.

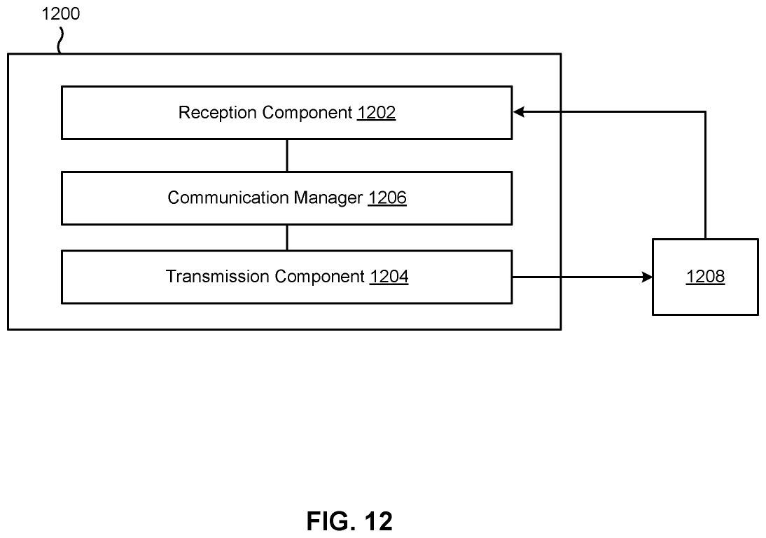

As shown in FIG. 11, in some aspects, process 1100 may include selecting sidelink resources for full duplex communication from among available sidelink resources (block 1110). For example, the UE (e.g., using communication manager 1206, depicted in FIG. 12) may select sidelink resources for full duplex communication from among available sidelink resources, as described above.

As further shown in FIG. 11, in some aspects, process 1100 may include communicating in full duplex using the selected sidelink resources (block 1120). For example, the UE (e.g., using reception component 1202, transmission component 1204, and/or communication manager 1206, depicted in FIG. 12) may communicate in full duplex using the selected sidelink resources, as described above.

Process 1100 may include additional aspects, such as any single aspect or any combination of aspects described below and/or in connection with one or more other processes described elsewhere herein.

In a first aspect, process 1100 includes sensing for the available sidelink resources from among candidate sidelink resources that include scheduled sidelink resources already scheduled for transmission or reception by the UE.

In a second aspect, alone or in combination with the first aspect, process 1100 includes receiving an indication of available sidelink resources, where selecting the sidelink resources includes selecting the sidelink resources for full duplex communication from among the available sidelink resources and from among scheduled sidelink resources that are already scheduled for transmission or reception by the UE.

In a third aspect, alone or in combination with one or more of the first and second aspects, communicating in full duplex includes transmitting a first sidelink communication and receiving a second sidelink communication in a same time resource, or transmitting or receiving a sidelink communication and transmitting or receiving an access link communication in the same time resource.

In a fourth aspect, alone or in combination with one or more of the first through third aspects, process 1100 includes determining to use full duplex communication based at least in part on one or more of a traffic condition, a channel condition, or a UE capability for full duplex communication.

In a fifth aspect, alone or in combination with one or more of the first through fourth aspects, process 1100 includes receiving a configuration for full duplex communication, where communicating in full duplex includes communicating in full duplex based at least in part on the configuration.

In a sixth aspect, alone or in combination with one or more of the first through fifth aspects, the configuration indicates whether full duplex communication is to be performed in slots of the selected sidelink resources or in a whole sensing window.

In a seventh aspect, alone or in combination with one or more of the first through sixth aspects, process 1100 includes selecting preferred sidelink resources for reception from among the available sidelink resources, and transmitting an indication of the preferred sidelink resources in an inter-UE coordination message.

In an eighth aspect, alone or in combination with one or more of the first through seventh aspects, process 1100 includes disabling a half-duplex check condition based at least in part on a higher layer parameter.

In a ninth aspect, alone or in combination with one or more of the first through eighth aspects, process 1100 includes selecting non-preferred sidelink resources, from a set of received sidelink resources, that are not available sidelink resources and that are not among time resources for which transmission is available with full duplex communication, and transmitting an indication of the non-preferred sidelink resources in an inter-UE coordination message.

In a tenth aspect, alone or in combination with one or more of the first through ninth aspects, process 1100 includes selecting conflicted sidelink resources that conflict with other sidelink resources and that are not among time resources for which transmission is available with full duplex communication, and transmitting an indication of the conflicted sidelink resources in an inter-UE coordination message.

In an eleventh aspect, alone or in combination with one or more of the first through tenth aspects, communicating in full duplex includes selecting, based at least in part on a transmission priority, a set of transmit channels or RSs from among overlapping-in-time transmit channels or RSs to other UEs, selecting, based at least in part on a reception priority, a set of receive channels or RSs from among overlapping-in-time receive channels or RSs from other UEs, and transmitting one or more first communications on the selected set of transmit channels or RSs and receiving one or more second communications on the selected set of receive channels or RSs in a same time resource.

In a twelfth aspect, alone or in combination with one or more of the first through eleventh aspects, a RAT of the set of transmit channels or RSs and a RAT of the set of receive channels or RSs are different.

In a thirteenth aspect, alone or in combination with one or more of the first through twelfth aspects, a type of the set of transmit channels and a type of the set of receive channels or RSs are the same.

In a fourteenth aspect, alone or in combination with one or more of the first through thirteenth aspects, a link type of the set of transmit channels or RSs and a link type of the set of receive channels or RSs are different.

In a fifteenth aspect, alone or in combination with one or more of the first through fourteenth aspects, process 1100 includes determining the transmission priority or the reception priority based at least in part on a scheduling message, an activating message, a configuration message, or a priority of a prior transmission associated with the transmission.

In a sixteenth aspect, alone or in combination with one or more of the first through fifteenth aspects, process 1100 includes determining the transmission priority or the reception priority based at least in part on a rule specified in stored configuration information.

In a seventeenth aspect, alone or in combination with one or more of the first through sixteenth aspects, process 1100 includes receiving an inter-UE coordination (IUC) message, where selecting the sidelink resources includes selecting the sidelink resources for full duplex communication further based at least in part on the IUC message.

In an eighteenth aspect, alone or in combination with one or more of the first through seventeenth aspects, the IUC message indicates preferred sidelink resources for another UE, and selecting the sidelink resources includes selecting the sidelink resources for full duplex communication further based at least in part on the preferred sidelink resources for the other UE.

In a nineteenth aspect, alone or in combination with one or more of the first through eighteenth aspects, the IUC message indicates non-preferred sidelink resources or conflicted resources for another UE, and selecting the sidelink resources includes selecting the sidelink resources for full duplex communication further based at least in part on the non-preferred sidelink resources or the conflicted resources for the other UE.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE (e.g., UE 120, UE 710, UE 720), or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 1-9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The communication manager 1206 may select sidelink resources for full duplex communication from among available sidelink resources. The reception component 1202 and/or the transmission component 1204 may communicate in full duplex using the selected sidelink resources.

The communication manager 1206 may sense for the available sidelink resources from among candidate sidelink resources that include scheduled sidelink resources already scheduled for transmission or reception by the UE.

The reception component 1202 may receive an indication of available sidelink resources, and the communication manager 1206 may select the sidelink resources for full duplex communication from among the available sidelink resources and from among scheduled sidelink resources that are already scheduled for transmission or reception by the UE.

The communication manager 1206 may determine to use full duplex communication based at least in part on one or more of a traffic condition, a channel condition, or a UE capability for full duplex communication. The reception component 1202 may receive a configuration for full duplex communication. The reception component 1202 and/or the transmission component 1204 may communicate in full duplex based at least in part on the configuration.

The communication manager 1206 may select preferred sidelink resources for reception from among the available sidelink resources. The transmission component 1204 may transmit an indication of the preferred sidelink resources in an IUC message. The communication manager 1206 may disable a half-duplex check condition based at least in part on a higher layer parameter.

The communication manager 1206 may select non-preferred sidelink resources, from a set of received sidelink resources, that are not available sidelink resources and that are not among time resources for which transmission is available with full duplex communication. The transmission component 1204 may transmit an indication of the non-preferred sidelink resources in an IUC message.

The communication manager 1206 may select conflicted sidelink resources that conflict with other sidelink resources and that are not among time resources for which transmission is available with full duplex communication. The transmission component 1204 may transmit an indication of the conflicted sidelink resources in an IUC message.

The communication manager 1206 may determine the transmission priority or the reception priority based at least in part on a scheduling message, an activating message, a configuration message, or a priority of a prior transmission associated with the transmission. The communication manager 1206 may determine the transmission priority or the reception priority based at least in part on a rule specified in stored configuration information.

The reception component 1202 may receive an IUC message, and the communication manager 1206 may select the sidelink resources for full duplex communication further based at least in part on the IUC message.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: selecting sidelink resources for full duplex communication from among available sidelink resources; and communicating in full duplex using the selected sidelink resources.

Aspect 2: The method of Aspect 1, further comprising sensing for the available sidelink resources from among candidate sidelink resources that include scheduled sidelink resources already scheduled for transmission or reception by the UE.

Aspect 3: The method of Aspect 2, further comprising receiving a configuration for full duplex communication, wherein communicating in full duplex includes communicating in full duplex based at least in part on the configuration.

Aspect 4: The method of Aspect 3, wherein the configuration indicates whether full duplex communication is to be performed in slots of the selected sidelink resources or in a whole sensing window.

Aspect 5: The method of any of Aspects 1-4, further comprising: selecting preferred sidelink resources for reception from among the available sidelink resources; and transmitting an indication of the preferred sidelink resources in an inter-UE coordination message.

Aspect 6: The method of any of Aspects 1-5, further comprising: selecting non-preferred sidelink resources, from a set of received sidelink resources, that are not available sidelink resources and that are not among time resources for which transmission is available with full duplex communication; and transmitting an indication of the non-preferred sidelink resources in an inter-UE coordination message.

Aspect 7: The method of any of Aspects 1-6, further comprising: selecting conflicted sidelink resources that conflict with other sidelink resources and that are not among time resources for which transmission is available with full duplex communication; and transmitting an indication of the conflicted sidelink resources in an inter-UE coordination message.

Aspect 8: The method of any of Aspects 1-7, further comprising receiving an indication of available sidelink resources, wherein selecting the sidelink resources includes selecting the sidelink resources for full duplex communication from among the available sidelink resources and from among scheduled sidelink resources that are already scheduled for transmission or reception by the UE.

Aspect 9: The method of any of Aspects 1-8, wherein communicating in full duplex includes: transmitting a first sidelink communication and receiving a second sidelink communication in a same time resource, or transmitting or receiving a sidelink communication and transmitting or receiving an access link communication in the same time resource.

Aspect 10: The method of any of Aspects 1-9, further comprising determining to use full duplex communication based at least in part on one or more of a traffic condition, a channel condition, or a UE capability for full duplex communication.

Aspect 11: The method of any of Aspects 1-10, further comprising disabling a half-duplex check condition based at least in part on a higher layer parameter.

Aspect 12: The method of any of Aspects 1-11, wherein communicating in full duplex includes: selecting, based at least in part on a transmission priority, a set of transmit channels or reference signals (RSs) from among overlapping-in-time transmit channels or RSs to other UEs; selecting, based at least in part on a reception priority, a set of receive channels or RSs from among overlapping-in-time receive channels or RSs from other UEs; and transmitting one or more first communications on the selected set of transmit channels or RSs and receiving one or more second communications on the selected set of receive channels or RSs in a same time resource.

Aspect 13: The method of Aspect 12, wherein a radio access technology (RAT) of the set of transmit channels or RSs and a RAT of the set of receive channels or RSs are different.

Aspect 14: The method of Aspect 12 or 13, wherein a type of the set of transmit channels and a type of the set of receive channels or RSs are the same.

Aspect 15: The method of any of Aspects 12-14, wherein a link type of the set of transmit channels or RSs and a link type of the set of receive channels or RSs are different.

Aspect 16: The method of any of Aspects 12-15, further comprising determining the transmission priority or the reception priority based at least in part on a scheduling message, an activating message, a configuration message, or a priority of a prior transmission associated with the transmission.

Aspect 17: The method of any of Aspects 12-16, further comprising determining the transmission priority or the reception priority based at least in part on a rule specified in stored configuration information.

Aspect 18: The method of any of Aspects 1-17, further comprising receiving an inter-UE coordination (IUC) message, wherein selecting the sidelink resources includes selecting the sidelink resources for full duplex communication further based at least in part on the IUC message.

Aspect 19: The method of Aspect 18, wherein the IUC message indicates preferred sidelink resources for another UE, and wherein selecting the sidelink resources includes selecting the sidelink resources for full duplex communication further based at least in part on the preferred sidelink resources for the other UE.

Aspect 20: The method of Aspect 18 or 19, wherein the IUC message indicates non-preferred sidelink resources or conflicted resources for another UE, and wherein selecting the sidelink resources includes selecting the sidelink resources for full duplex communication further based at least in part on the non-preferred sidelink resources or the conflicted resources for the other UE.

Aspect 21: An apparatus for wireless communication at a device, comprising a processor; memory coupled with the processor; and instructions stored in the memory and executable by the processor to cause the apparatus to perform the method of one or more of Aspects 1-20.

Aspect 22: A device for wireless communication, comprising a memory and one or more processors coupled to the memory, the one or more processors configured to perform the method of one or more of Aspects 1-20.

Aspect 23: An apparatus for wireless communication, comprising at least one means for performing the method of one or more of Aspects 1-20.

Aspect 24: A non-transitory computer-readable medium storing code for wireless communication, the code comprising instructions executable by a processor to perform the method of one or more of Aspects 1-20.

Aspect 25: A non-transitory computer-readable medium storing a set of instructions for wireless communication, the set of instructions comprising one or more instructions that, when executed by one or more processors of a device, cause the device to perform the method of one or more of Aspects 1-20.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
select sidelink resources for full duplex communication from among available sidelink resources; and
communicate in full duplex using the selected sidelink resources.

2. The UE of claim 1, wherein the one or more processors are configured to sense for the available sidelink resources from among candidate sidelink resources that include scheduled sidelink resources already scheduled for transmission or reception by the UE.

3. The UE of claim 2, wherein the one or more processors are configured to receive a configuration for full duplex communication, wherein communicating in full duplex includes communicating in full duplex based at least in part on the configuration.

4. The UE of claim 3, wherein the configuration indicates whether full duplex communication is to be performed in slots of the selected sidelink resources or in a whole sensing window.

5. The UE of claim 2, wherein the one or more processors are configured to:
select preferred sidelink resources for reception from among the available sidelink resources; and
transmit an indication of the preferred sidelink resources in an inter-UE coordination message.

6. The UE of claim 2, wherein the one or more processors are configured to:
select non-preferred sidelink resources, from a set of received sidelink resources, that are not available sidelink resources and that are not among time resources for which transmission is available with full duplex communication; and
transmit an indication of the non-preferred sidelink resources in an inter-UE coordination message.

7. The UE of claim 2, wherein the one or more processors are configured to:
select conflicted sidelink resources that conflict with other sidelink resources and that are not among time resources for which transmission is available with full duplex communication; and
transmit an indication of the conflicted sidelink resources in an inter-UE coordination message.

8. The UE of claim 1, wherein the one or more processors are configured to receive an indication of available sidelink resources, and wherein the one or more processors, to select the sidelink resources, are configured to select the sidelink resources for full duplex communication from among the available sidelink resources and from among scheduled sidelink resources that are already scheduled for transmission or reception by the UE.

9. The UE of claim 1, wherein the one or more processors, to communicate in full duplex, are configured to:
transmit a first sidelink communication and receiving a second sidelink communication in a same time resource, or
transmit or receive a sidelink communication and transmit or receive an access link communication in the same time resource.

10. The UE of claim 1, wherein the one or more processors are configured to determine to use full duplex communication based at least in part on one or more of a traffic condition, a channel condition, or a UE capability for full duplex communication.

11. The UE of claim 1, wherein the one or more processors are configured to disable a half-duplex check condition based at least in part on a higher layer parameter.

12. The UE of claim 1, wherein the one or more processors, to communicate in full duplex, are configured to:
select, based at least in part on a transmission priority, a set of transmit channels or reference signals (RSs) from among overlapping-in-time transmit channels or RSs to other UEs;
select, based at least in part on a reception priority, a set of receive channels or RSs from among overlapping-in-time receive channels or RSs from other UEs; and
transmit one or more first communications on the selected set of transmit channels or RSs and receiving one or more second communications on the selected set of receive channels or RSs in a same time resource.

13. The UE of claim 12, wherein a radio access technology (RAT) of the set of transmit channels or RSs and a RAT of the set of receive channels or RSs are different.

14. The UE of claim 12, wherein a type of the set of transmit channels and a type of the set of receive channels or RSs are the same.

15. The UE of claim 12, wherein a link type of the set of transmit channels or RSs and a link type of the set of receive channels or RSs are different.

16. The UE of claim 12, wherein the one or more processors are configured to determine the transmission priority or the reception priority based at least in part on a scheduling message, an activating message, a configuration message, or a priority of a prior transmission associated with the transmission.

17. The UE of claim 12, wherein the one or more processors are configured to determine the transmission priority or the reception priority based at least in part on a rule specified in stored configuration information.

18. The UE of claim 1, wherein the one or more processors are configured to receive an inter-UE coordination (IUC) message, and wherein the one or more processors, to select the sidelink resources, are configured to select the sidelink resources for full duplex communication further based at least in part on the IUC message.

19. The UE of claim 18, wherein the IUC message indicates preferred sidelink resources for another UE, and wherein the one or more processors, to select the sidelink resources, are configured to select the sidelink resources for full duplex communication further based at least in part on the preferred sidelink resources for the other UE.

20. The UE of claim 18, wherein the IUC message indicates non-preferred sidelink resources or conflicted resources for another UE, and wherein the one or more processors, to select the sidelink resources, are configured to select the sidelink resources for full duplex communication further based at least in part on the non-preferred sidelink resources or the conflicted resources for the other UE.
